(19) United States
(12) Patent Application Publication
(10) Pub. No.: US 2012/0117795 A1
(43) Pub. Date: May 17, 2012

(54) WORKPIECE SUPPLYING DEVICE

(75) Inventor: HAI-LONG ZOU, Shenzhen City (CN)

(73) Assignees: HON HAI PRECISION INDUSTRY CO., LTD., New Taipei (TW); HONG FU JIN PRECISION INDUSTRY (ShenZhen) CO., LTD., Shenzhen City (CN)

(21) Appl. No.: 13/030,087

(22) Filed: Feb. 17, 2011

(30) Foreign Application Priority Data
Nov. 17, 2010 (CN) 201010548660.5

(51) Int. Cl. B23Q 7/10

(52) U.S. Cl. 29/812.5

(57) ABSTRACT

A workpiece supplying device for spacing a number of workpieces includes a transportation plate and a spacing block. The transportation plate includes a first end and an opposite second end, a feed track extending from the first end to the second end, and a guiding slot communicating with the feed track. The feed track feeds the number of workpieces from the first end to the second end in sequence. The spacing block is slidable along the guiding slot to space every two neighboring workpieces in the feed track.

### BACKGROUND

1. Technical Field

The disclosure generally relates to workpiece supplying devices and, particularly, to a workpiece supplying device with a spacing block for spacing workpieces on a feed track.

2. Description of Related Art

Automatic riveting machines are used to automatically set (squeeze) rivets in order to join materials together. The riveting machine offers greater consistency, productivity, and lower cost when compared to manual riveting.

A typical riveting machine includes a feed riveting machine and a setting tool. The feed riveting machine includes a hopper and a feed track. The hopper and the feed track cooperate to deliver and position the rivets. The setting tool is used to provide downward force to deform each positioned rivet.

One drawback of the typical riveting machine is that the rivets are delivered all the way along the feed track, and cannot be spaced from each other. Therefore, one rivet follows another rivet with no delay, causing the rivet tool to engage the next rivet without pause, which does not allow for precision placement of the rivets. When the rivets are poorly positioned, the rivets cannot be set to firmly join materials together.

Therefore, what is needed, is a workpiece supplying device, which can overcome the above shortcomings.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is an isometric view of a workpiece supplying device in accordance with an embodiment, the workpiece supplying device including a spacing block.

FIG. 2 is a top plan view of the workpiece supplying device of FIG. 1, showing the spacing block being moved toward an extended position.

FIG. 3 is similar to FIG. 2, but showing the spacing block being located at the extended position.

FIG. 4 is similar to FIG. 2, but showing the spacing block being located at a retracted position.

### DETAILED DESCRIPTION

Embodiments of the workpiece supplying device will now be described in detail below and with reference to the drawings.

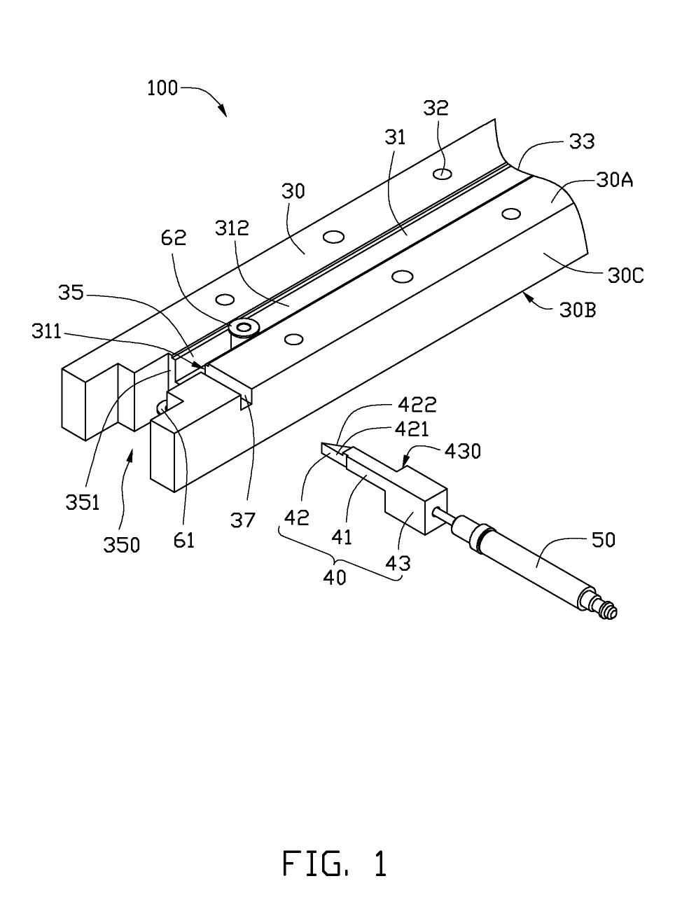

Referring to FIG. 1, a workpiece supplying device 100 in accordance with an embodiment is shown. The workpiece supplying device 100 includes a transportation plate 30, a spacing block 40, and an actuator 50.

In this embodiment, the transportation plate 30 is substantially cuboid-shaped, and includes a top surface 30A, a bottom surface 30B, and a peripheral surface 30C. The top surface 30A and the bottom surface 30B are located at opposite sides of the transportation plate 30, and substantially parallel to each other. The peripheral surface 30C is located between and adjoins the top surface 30A and the bottom surface 30B.

The transportation plate 30 includes a first end 33 and a second end 35 opposite to the first end 33. In this embodiment, the transportation plate 30 has a feed track 31 defined in the top surface 30A, and a guiding slot 37 defined in the peripheral surface 30C. The feed track 31 extends in a direction from the first end 33 to the second end 35. The transportation plate 30 includes a first lateral surface 311 and a second lateral surface 312 in the feed track 31. The first lateral surface 311 is arranged opposite to the second lateral surface 312, and is substantially parallel to the second lateral surface 312. In this embodiment, a lengthwise direction of the feed track 31 is horizontally oriented, and a lengthwise direction of the guiding slot 37 is substantially perpendicular to the feed track 31. In addition, the transportation plate 30 has a number of threaded holes 32 defined in the top surface 30A. Each of the fixing holes 32 extends through the bottom surface 30B.

The transportation plate 30 is used to upload a number of workpieces from, a hopper or magazine (not shown) for example. The feed track 31 is configured for feeding the workpieces from the first end 33 to the second end 35. In this embodiment, the workpiece may, be a rivet 61 or 62 for example, and a width of the rivet 61 or 62 is equal to that of the feed track 31.

The second end 35 has a groove 350 defined in the top surface 30A. The groove 350 extends through the bottom surface 30B. The transportation plate 30 includes an inner surface 351 in the groove 350. The inner surface 351 adjoins the first and the second lateral surfaces 310 and 312. The feed track 31 extends toward and terminates at the inner surface 351. In assembly, the transportation plate 30 is arranged on a table (not shown), a number of fixing elements, for example screws can be provided to and threadedly engaged in the respective threaded holes 32 to fix the transportation plate 30 on the table. In use, the top surface 30A or the bottom surface 30B is horizontally oriented. In this embodiment, a belt, such as a timing belt can be provided and located adjacent to the bottom surface 30B of the transportation plate 30. And the belt can be used to transport the rivets 61 and 62 from the first end 33 to the groove 350 of the second end 35. The rivets 61 and 62 can be positioned in the groove 350 at intervals, such that a setting tool (not shown) can be provided to set the rivets 61 and 62 to join given materials together.

The spacing block 40 includes a guiding portion 41, an engaging portion 42, and a connecting portion 43. The engaging portion 42 extends from an end of the guiding portion 41. The connecting portion 43 protrudes from the guiding portion 41 in a direction facing away from the engaging portion 42. Each of the guiding portion 41 and the connecting portion 43 is substantially cuboid-shaped. In this embodiment, a sectional surface area of the connecting portion 43 is greater than that of guiding portion 41. A step 430 is formed between the engaging portion 42 and the connecting portion 43.

The engaging portion 42 tapers in a direction away from the guiding portion 41. In this embodiment, the engaging portion 42 is substantially triangular prism-shaped, and the engaging portion 42 includes, for example a first surface 421 and second surface 422.

The spacing block 40 is slidably attached to the transportation plate 30. In this embodiment, the guiding portion 41 is engagingly received in the guiding slot 37. The first surface 421 is nearer to the groove 350. The second surface 422 is further from the groove 350, and the second surface 422 adjoins the first surface 421 and is inclined relative to the first surface 421. The lengthwise direction of the feed track 31 is substantially perpendicular to the first surface 421. That is, a first surface 421 is substantially perpendicular to the first lateral surface 311 or the second lateral surface 312. An angle defined between the first and the second surfaces 421 and 422 is about 30 degrees.

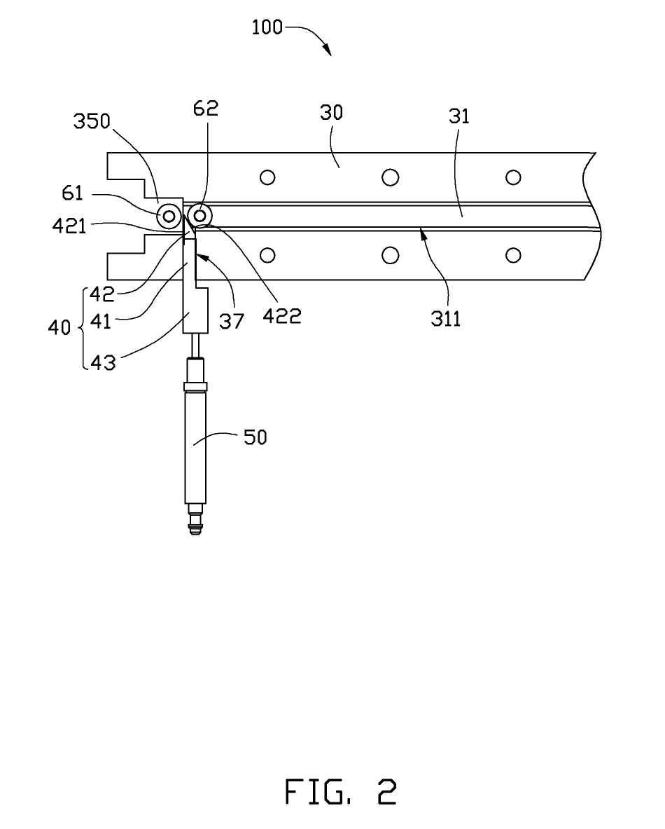

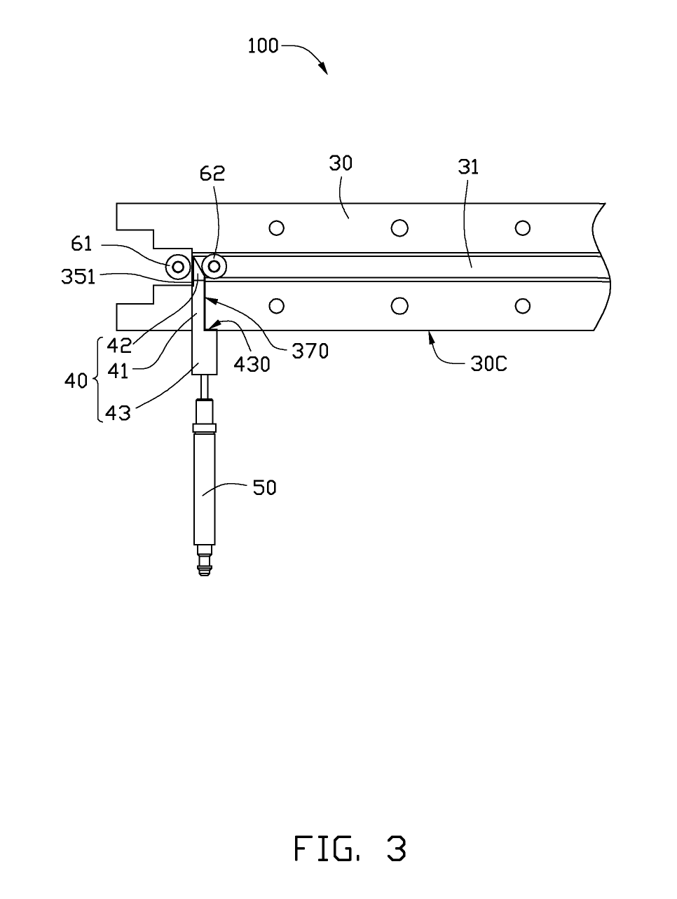

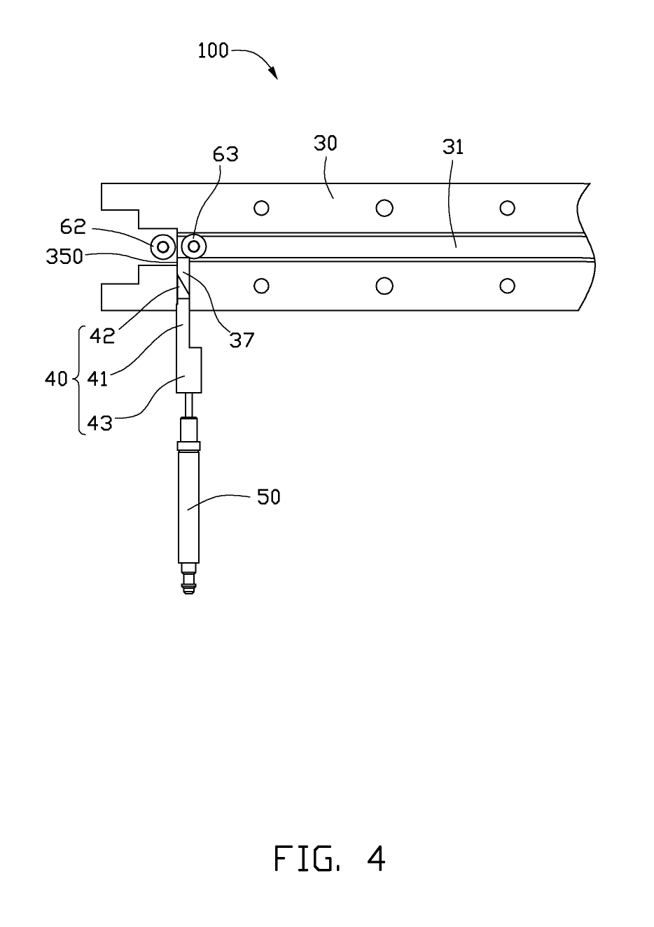

Referring further to FIG. 2, FIG. 3, and FIG. 4, the actuator 50 is coupled to the connecting portion 43 of the spacing block 40. And the actuator 50 is used to move the spacing block 40 to space every two neighboring rivets, for example the rivets 61 and 62 in FIG. 2 and FIG. 3, or the rivets 62 and 63 in FIG. 4 along the feed track 31. In this embodiment, the actuator 50 is a pneumatic cylinder or a hydraulic cylinder.

In operation, the spacing block 40 is moved by the actuator 50 between an extended position and a retracted position. As shown in FIG. 2, when the spacing block 40 is moved toward the extended position, the guiding portion 41 slides along the guiding slot 37. In addition, the engaging portion 42 protrudes from the first lateral surface 311, and is further inserted into the feed track 31 to space two neighboring rivets 61 and 62. The first surface 421 of the engaging portion 42 engages the rivet 61 nearer to the groove 350, and the second surface 422 of the engaging portion 42 engages the rivet 62 further from the groove 350. As shown in FIG. 3, when the spacing block 40 is moved to be located at the extended position, the step 430 engages the peripheral surface 30C. Engagement of the step 430 and the peripheral surface 30C restrains the guiding portion 41 from further sliding along the guiding slot 37. As such, the two rivets 61 and 62 are spaced to locate at two opposite sides of the engaging portion 42. The rivet 61 is spaced to be located at a side of the engaging portion 42 nearer to the groove 350. The rivet 62 is spaced to be located at a side of the engaging portion 42 further from the groove 350. Subsequently, the belt can transport the rivet to the groove 350, while the rivet 62 is blocked by the spacing block 40 to remain still in the feed track 31. When the rivet 61 is positioned in the groove 350, the setting tool can be used to set the rivet 61 to join given materials together. Furthermore, when the rivet 61 is set, the rivet 60 and the given materials can be removed from the groove 350.

As showed in FIG. 4, the spacing block 40 can be moved away from the feed track 31 to be located at the retraction position by the actuator 50. During movement of the spacing block 40, the engaging portion 42 is retracted from the feed track 31 and is received in the guiding slot 37. Therefore, the rivet 62, which is previously further to the groove 350, can be moved by the belt along the feed track 31 to be located nearer to the groove 350, and a subsequent rivet 63 can be moved to a position, which is previously occupied by the rivet 62. Subsequently, the spacing block 40 can be moved again to the extended position to space the rivets 62 and 63.

As described above, the spacing block 40 can be moved between the extended position and the retraction position, thus the spacing block 40 can be used to successively space every two neighboring workpieces along the feed track 31. In this embodiment, the workpiece supplying device 100 may includes a programmable logic controller (PLC) to control operation of the actuator 50, such that extension and retraction of the spacing block 40 can be controlled to operate alternately and automatically.

One advantage of the workpiece supplying device 100 is that the workpiece supplying device 100 is equipped with the spacing block 40, and the spacing block 40 can be used to space every two neighboring rivets 61, 62, 63 along the feed track 31. The rivets 61, 62, and 63 can be precisely positioned in the groove 350 at intervals. As the rivets 61, 62, and 63 can be precisely positioned, the rivets 61, 62, and 63 thus can be set to firmly join materials together.

It is understood that the above-described embodiment is intended to illustrate rather than limit the disclosure. Variations may be made to the embodiment without departing from the spirit of the disclosure. Accordingly, it is appropriate that the appended claims be construed broadly and in a manner consistent with the scope of the disclosure.

What is claimed is:

1. A workpiece supplying device for spacing a plurality of workpieces, the workpiece supplying device comprising:
a transportation plate comprising a first end and a second end opposite to the first end, a feed track extending from the first end to the second end, and a guiding slot communicating with the feed track, the feed track being configured for feeding the plurality of workpieces from the first end to the second end in sequence; and
a spacing block configured for being slidable along the guiding slot to space every two neighboring workpieces in the feed track.

2. The workpiece supplying device of claim 1, wherein the spacing block comprises a guiding portion and an engaging portion extending from the guiding portion, the guiding portion is engagingly received in the guiding slot, the engaging portion tapers in a direction away from the guiding portion and is configured for spacing two neighboring workpieces in the feed track.

3. The workpiece supplying device of claim 2, wherein the spacing block comprises a connecting portion extending from the guiding portion in a direction away from the engaging portion, a sectional surface area of the connecting portion is greater than that of guiding portion, a step is formed between the guiding portion and the connecting portion.

4. The workpiece supplying device of claim 3, further comprising an actuator coupled to the connecting portion of the spacing block, the actuator being configured for moving the spacing block between an extended position where the engaging portion protrudes from the guiding slot and is inserted in the feed track, and a retracted position where the engaging portion is retracted and received in the guiding slot.

5. The workpiece supplying device of claim 4, wherein the actuator is a pneumatic cylinder or a hydraulic cylinder.

6. The workpiece supplying device of claim 2, wherein the engaging portion is substantially triangular prism-shaped.

7. The workpiece supplying device of claim 6, wherein the transportation plate has a groove defined at the second end, the workpieces are fed in sequence to the second end to be positioned in the groove.

8. The workpiece supplying device of claim 7, wherein the engaging portion includes a first surface nearer to the groove and a second surface further from the groove, the second surface adjoins the first surface and is inclined relative to the first surface, a lengthwise direction of the feed track being substantially perpendicular to the first surface, an angle between the first surface and the second surface being about 30 degrees.

9. The workpiece supplying device of claim 1, wherein each workpiece is a rivet, a width of the rivet is equal to that of the feed track.

10. The workpiece supplying device of claim 1, wherein a lengthwise direction of the feed track is horizontally oriented.
